(19) United States
(12) Patent Application Publication
(10) Pub. No.: US 2026/0176151 A1
(43) Pub. Date: Jun. 25, 2026

(54) Method for digesting bauxite slurry

(71) Applicant: ZHENGZHOU NON-FERROUS METALS RESEARCH INSTITUTE CO. LTD OF CHALCO, Zhengzhou (CN)

(72) Inventors: Lijuan QI, Zhengzhou (CN); Jie ZHENG, Zhengzhou (CN); Xiaotao LU, Zhengzhou (CN); Huibin YANG, Zhengzhou (CN); Jianqiang ZHANG, Zhengzhou (CN); Shuai SHAO, Zhengzhou (CN); Shaojie KANG, Zhengzhou (CN); Shuyao WEI, Zhengzhou (CN); Qing YU, Zhengzhou (CN); Xiaoge GUAN, Zhengzhou (CN); Gengbiao XIE, Zhengzhou (CN)

(73) Assignee: ZHENGZHOU NON-FERROUS METALS RESEARCH INSTITUTE CO. LTD OF CHALCO, Zhengzhou, HE (CN)

(21) Appl. No.: 19/537,375

(22) Filed: Feb. 11, 2026

Related U.S. Application Data
(63) Continuation of application No. PCT/CN2024/104212, filed on Jul. 8, 2024.

(30) Foreign Application Priority Data
Sep. 7, 2023 (CN) 202311151987.2

(51) Int. Cl. C01F 7/062; B01D 21/24; C01F 7/066

(52) U.S. Cl. CPC C01F 7/062; B01D 21/2461; C01F 7/066; C04B 2235/3418

(57) ABSTRACT

Disclosed is a method for digesting a bauxite slurry is disclosed. The method comprises: obtaining a raw bauxite slurry; pre-desilicating the raw bauxite slurry to obtain a pre-desilicated slurry; preheating the pre-desilicated slurry to obtain a dephosphorized slurry; and digesting the dephosphorized slurry to obtain a digested bauxite slurry.

### CROSS-REFERENCE TO RELATED APPLICATIONS

This application is a continuation of International Patent Application No. PCT/CN2024/104212, filed on Jul. 8, 2024, which claims priority to Chinese Patent Application No. 202311151987.2, filed on Sep. 7, 2023. The disclosures of the above-referenced applications are hereby incorporated by reference in their entirety.

### TECHNICAL FIELD

The disclosure relates to the field of alumina production, and in particular, to a method for digesting a bauxite slurry.

### BACKGROUND

Scaling problems occur throughout the entire alumina production process, which includes raw slurry preparation, digestion, settling, decomposition, and evaporation. Among these, scaling generated during the digestion process is particularly severe. During a high-temperature digestion process, a phosphorus scale is generated, with hydroxyapatite as main component. This scale stably and firmly adheres to the inner walls of pipelines and storage tanks in the production process, greatly impacting alumina production process.

Alumina production enterprises mostly slow down formation of scaling by adding pre-desilication steps, adding scale inhibitors and other means, but these methods are not very effective in slowing down phosphate scale (hydroxyapatite). The phosphorus scale has a hard texture and is difficult to clean, seriously affecting operation cycles. Scale inhibitors are generally organic substances. Adding scale inhibitors may introduce a risk of increased organic matter or impurities in a system. Currently, acid leaching and high-pressure water rinsing are commonly used for scale removal, which is costly.

### SUMMARY

A technical problem of phosphorus scaling easily occurring in pipelines during a digestion of a bauxite slurry is solved by utilizing one or more embodiments of the disclosure.

A method for digesting a bauxite slurry is provided according to some embodiments of the disclosure. The method comprises: obtaining a raw bauxite slurry; pre-desilicating the raw bauxite slurry to obtain a pre-desilicated slurry; preheating the pre-desilicated slurry to obtain a dephosphorized slurry; digesting the dephosphorized slurry to obtain a digested bauxite slurry.

### BRIEF DESCRIPTION OF DRAWINGS

The drawings, which are incorporated into and constitute a portion of the specification, illustrate embodiments consistent with the disclosure and, together with the description, serve to explain the principles of the disclosure.

To describe the technical solutions in the embodiments of the disclosure or in the related art more clearly, the drawings required for describing the embodiments or the related art will be briefly introduced below. Obviously, for those skilled in the art, other drawings can also be derived from these drawings without creative effort.

FIG. 1 shows a schematic flow chart of a method for digesting a bauxite slurry according to some embodiments of the disclosure.

### DETAILED DESCRIPTION

To make the objectives, technical solutions and advantages of the embodiments of the disclosure clearer, the technical solutions in the embodiments of the disclosure will be clearly and completely described below with reference to the drawings in the embodiments of the disclosure. Obviously, the described embodiments are some embodiments of the disclosure, rather than all the embodiments. All other embodiments obtained by those skilled in the art based on the embodiments in this disclosure without creative effort shall fall within the scope of protection of the disclosure.

Various embodiments of the disclosure may be described in a range form; it should be understood that descriptions in a range form are for convenience and brevity only, and should not be construed as a rigid limitation on the scope of the disclosure. Therefore, the described range should be considered to have specifically disclosed all possible sub-ranges as well as individual numerical values within that range. For example, it should be assumed that the range description from 1 to 6 has specifically disclosed sub-ranges, such as from 1 to 3, from 1 to 4, from 1 to 5, from 2 to 4, from 2 to 6, from 3 to 6, etc., and individual numbers within the range, such as 1, 2, 3, 4, 5 and 6, regardless of the range. Additionally, whenever a numerical range is indicated herein, it is meant to include any cited number (fraction or integer) within the indicated range.

In the disclosure, unless otherwise stated, the directional terms such as “upper” and “lower” specifically refer to the directions in the drawings. Moreover, in the description of the specification of the disclosure, the terms “including”, “comprising”, and the like, mean “including but not limited to”. In this document, relational terms such as “first” and “second” are used merely to distinguish one entity or operation from another entity or operation, and do not necessarily require or imply any such actual relationship or order between these entities or operations. In this document, “and/or”, describing an association relationship of associated objects, indicates that three relationships may exist. For example, A and/or B may represent: A exists alone, A and B exist simultaneously, or B exists alone, where A and B may be singular or plural. In this document, “at least one” means one or more, and “a plurality of” means two or more. “At least one of”, “at least one item of the following”, or similar expressions thereof, refer to any combination of these items, including any combination of a singular item or plural items. For example, “at least one of a, b, or c”, or “at least one of a, b, and c”, may mean: a, b, c, ab (i.e., a and b), ac, bc, or abc, where a, b, and c may each be a single one or a plurality.

Unless otherwise specified, various raw materials, reagents, instruments and apparatus used in the disclosure can be obtained through market purchase or can be prepared by relevant methods.

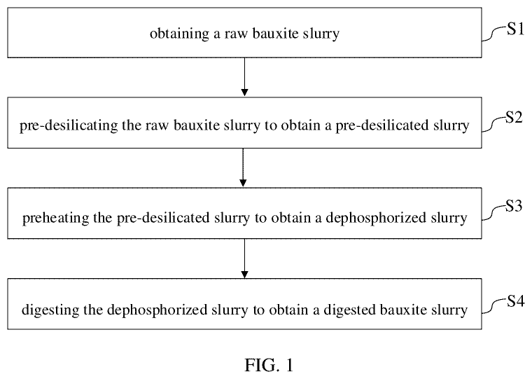

A method for digesting a bauxite slurry according to some embodiments of the disclosure is provided. Referring to FIG. 1, the method includes:
Step S1: obtaining a raw bauxite slurry;
Step S2: pre-desilicating the raw bauxite slurry to obtain a pre-desilicated slurry;
Step S3: preheating the pre-desilicated slurry to obtain a dephosphorized slurry; and,
Step S4: digesting the dephosphorized slurry to obtain a digested bauxite slurry.

In some embodiments, Step S1, obtaining the raw bauxite slurry includes: grinding a bauxite, lime, circulating mother liquor, and red mud to obtain the raw bauxite slurry.

In the above raw materials for the raw bauxite slurry, a bauxite is core raw material for alumina production. A function of the lime is that: for diaspore-type bauxite, the lime can both eliminate an influence of titanium minerals to promote a digestion of alumina, and cause phosphorus minerals to form hydroxyapatite to reduce a phosphorus content in the system; for gibbsite-type bauxite, adding lime is mainly used to cause phosphorus minerals to form hydroxyapatite to reduce the phosphorus content in a system. A function of the circulating mother liquor is to digest alumina in bauxite, and a chemical composition of the circulating mother liquor may be NaOH, NaAl(OH)₄, etc. A function of the red mud is to serve as a seed crystal to promote the formation of hydroxyapatite.

In some embodiments, an added weight of the red mud is 1% to 10% of an added weight of the bauxite.

In some embodiments of the disclosure, the added weight of the red mud is controlled to range from 1% to 10% of the added weight of the bauxite. The red mud can serve as a seed crystal to promote the formation of hydroxyapatite. If the added amount of the red mud is excessive, a solid content of the slurry is increased to a certain extent, increasing a burden of settling for red mud. If an added amount of the red mud is insufficient, beneficial effects of the red mud in promoting the formation of hydroxyapatite are weakened to a certain extent. In some embodiments, the added weight of the red mud may be 1%, 2%, 4%, 6%, 8%, 10%, etc., of the added weight of the bauxite.

In some embodiments, an added weight of the lime is 3% to 12% of the added weight of the bauxite.

The added weight of the lime is controlled to range from 3% to 12% of the added weight of the bauxite. For diaspore-type bauxite, the lime can both eliminate the influence of titanium minerals to promote the digestion of alumina, and cause phosphorus minerals to form hydroxyapatite, reducing a phosphorus content in the system. For gibbsite-type bauxite, adding lime is mainly used to cause phosphorus minerals to form hydroxyapatite, reducing the phosphorus content in a system. If an added amount of the lime is excessive, a loss of alumina is caused to a certain extent. If the added amount of the lime is insufficient, beneficial effects of eliminating the influence of titanium minerals to promote the digestion of alumina and causing phosphorus minerals to form hydroxyapatite are weakened. In some embodiments, the added weight of the lime may be 3%, 5%, 7%, 9%, 11%, 12%, etc., of the added weight of the bauxite.

In some embodiments, in Step S2 of pre-desilicating the raw bauxite slurry to obtain the pre-desilicated slurry, process parameters for pre-desilication may include: a pre-desilication temperature, a pre-desilication time, and a pre-desilication solid content; where, the pre-desilication temperature ranges from 90° C. to 105° C., the pre-desilication time ranges from 6 h to 15 h, and the pre-desilication solid content ranges from 300 g/L to 1000 g/L.

In some embodiments of the disclosure, a pre-desilication step is set up, which can slow down a formation of silicon scale (sodium silicate slag, cancrinite, hydrogarnet, etc.) and titanium scale (perovskite, hydroxy perovskite). A pre-desilication temperature is controlled to promote a reaction of silicon minerals in the bauxite to form sodium silicate slag, thereby increasing desilication efficiency and slowing down the formation of silicon scale.

In some embodiments, the pre-desilication temperature may be 90° C., 95° C., 100° C., 105° C., etc. The pre-desilication time is controlled to range from 6 h to 15 h, which can promote the reaction of silicon minerals in the bauxite to form sodium silicate slag, thereby increasing desilication efficiency and slowing down the formation of silicon scale.

In some embodiments, the pre-desilication time may be 6 h, 9 h, 12 h, 15 h, etc. If the pre-desilication temperature is too high or the pre-desilication time is too long, to a certain extent, an energy consumption is increased. If the pre-desilication temperature is too low or the pre-desilication time is too short, to a certain extent, the reaction of silicon minerals is insufficient, resulting in low desilication efficiency. The pre-desilication solid content is controlled to range from 300 g/L to 1000 g/L. This pre-desilication solid content can increase a SiO₂ concentration in the slurry, while causing the reaction to generate more sodium silicate slag. The sodium silicate slag, as a seed crystal, further promotes desilication of the solution, having a positive effect on slowing down scaling. If the pre-desilication solid content is too high, to a certain extent, a viscosity of the pre-desilicated slurry is increased, resulting in poor fluidity and difficulty in transportation of the pre-desilicated slurry. If the pre-desilication solid content is too low, to a certain extent, a desilication effect is poor, and a molecular ratio of a subsequent digested liquor is relatively high, resulting in low production efficiency. In some embodiments, the pre-desilication solid content may be 300 g/L, 400 g/L, 500 g/L, 600 g/L, 700 g/L, 800 g/L, 900 g/L, 1000 g/L, etc.

In some embodiments, in Step S3 of preheating the pre-desilicated slurry to obtain the dephosphorized slurry, preheating process parameters include: a preheating temperature and a preheating time.

In some embodiments, the preheating temperature may range from 220° C. to 260° C.

In some embodiments, the preheating temperature may range from 240° C. to 260° C.

A preheating step is set up, i.e., a dephosphorization step is set up, which can slow down phosphorus scaling during the digestion process and, while slowing down the formation of silicon and titanium scale, can also slow down the formation of phosphorus scale, thereby effectively extending an operation cycle and reducing the number of scale cleaning.

In some embodiments of the disclosure, the preheating temperature is controlled to range from 220° C. to 260° C. A reaction rate of phosphorus minerals in an ore is higher within this temperature range, which is more conducive to phosphorus minerals forming hydroxyapatite and entering the red mud, resulting in a better dephosphorization effect. Generally, a temperature for high-temperature digestion of bauxite ranges from 260° C. to 280° C. The preheating temperature does not need to be higher than the digestion temperature. When the preheating temperature is too high, requirements for apparatus and pipelines are higher, thus investment costs are higher. If the preheating temperature is too low, to a certain extent, a reaction rate of phosphorus minerals is lower, resulting in insufficient dephosphorization. In some embodiments, the preheating temperature may be 220° C., 230° C., 240° C., 250° C., 260° C., etc. In other embodiments, the preheating temperature may range from 240° C. to 260° C.

In some embodiments, the preheating time is greater than 30 min.

The preheating time is controlled to be greater than 30 min, which is conducive to a more complete reaction of phosphorus minerals, thereby achieving a better dephosphorization effect. If the time is too short, to a certain extent, a dephosphorization effect is poorer. In some embodiments, the preheating time may be 40 min, 50 min, 60 min, 70 min, etc.

In some embodiments, in Step S4 of digesting the dephosphorized slurry to obtain the digested bauxite slurry, a temperature of the digesting ranges from 260° C. to 280° C.

A temperature of the digesting is controlled to be 260° C. to 280° C., which can give rise to a good alumina digestion effect and high digestion rate. If a digestion temperature is too high, to a certain extent, requirements for apparatus and pipelines are higher, thereby significantly increasing investment costs. If the digestion temperature is too low, to a certain extent, an alumina digestion rate is reduced. In some embodiments, the temperature of the digesting may be 260° C., 265° C., 270° C., 275° C., 280° C., etc. After Step S4, alumina production can be continued.

The technical solutions of the disclosure are further described below in combination with specific examples. It should be understood that these examples are only used to illustrate the disclosure and not to limit the scope of the disclosure. For experimental methods without specific conditions noted in the following examples, measurements are generally carried out in accordance with national standards. If there is no corresponding national standard, then follow the general international standards, conventional conditions, or conditions recommended by the manufacturer.

A method for digesting a bauxite slurry according to some embodiments of the disclosure includes:
S1: obtaining a raw bauxite slurry;
S2: pre-desilicating the raw bauxite slurry to obtain a pre-desilicated slurry;
S3: preheating the pre-desilicated slurry to obtain a dephosphorized slurry; and,
S4: digesting the dephosphorized slurry to obtain a digested bauxite slurry. Implementation process parameters for the method are shown in Examples 1-8 and Comparative Examples 1-2 below.

### Comparative Example 1

Bauxite #1, with a P₂O₅ content of 0.15%, was used for alumina production. First, the bauxite, lime, and a circulating mother liquor were ball-milled according to a certain proportion to prepare a raw bauxite slurry. In the raw bauxite slurry, an added amount of lime was 5% of the weight of the bauxite. The raw bauxite slurry was pre-desilicated under conditions of a pre-desilication temperature of 90° C., a pre-desilication time of 8 h, and a pre-desilication solid content of 400 g/L to obtain a pre-desilicated slurry. The pre-desilicated slurry was preheated to 265° C. to obtain a dephosphorized slurry. The dephosphorized slurry was digested for 60 min to obtain a digested bauxite slurry.

### Comparative Example 2

Bauxite #2, with a P₂O₅ content of 0.25%, was used for alumina production. First, the bauxite, lime, and a circulating mother liquor were ball-milled according to a certain proportion to prepare a raw bauxite slurry. In the raw bauxite slurry, an added amount of lime was 9% of the weight of the bauxite. The raw bauxite slurry was pre-desilicated under conditions of a pre-desilication temperature of 90° C., a pre-desilication time of 8 h, and a pre-desilication solid content of 400 g/L to obtain a pre-desilicated slurry. The pre-desilicated slurry was preheated to 265° C. to obtain a dephosphorized slurry. The dephosphorized slurry was digested for 60 min to obtain a digested bauxite slurry.

### Example 1

Bauxite #1 was treated using this technical solution. The bauxite, lime, a circulating mother liquor, and a small amount of red mud were ball-milled according to a certain proportion to prepare a raw bauxite slurry. In the raw bauxite slurry, an added amount of lime was 5% of the weight of the bauxite, and an added amount of red mud was 2% of the weight of the bauxite. The raw bauxite slurry was pre-desilicated under conditions of a pre-desilication temperature of 95° C., a pre-desilication time of 8 h, and a pre-desilication solid content of 400 g/L to obtain a pre-desilicated slurry. The pre-desilicated slurry was preheated to 230° C. and then kept at that temperature in a pressure cooker for 60 min to obtain a dephosphorized slurry. Then, the dephosphorized slurry was heated to 265° C. and digested for 60 min to obtain a digested bauxite slurry.

### Example 2

Bauxite #1 was treated using this technical solution. The bauxite, lime, a circulating mother liquor, and a small amount of red mud were ball-milled according to a certain proportion to prepare a raw bauxite slurry. In the raw bauxite slurry, an added amount of lime was 5% of the weight of the bauxite, and an added amount of red mud was 5% of the weight of the bauxite. The raw bauxite slurry was pre-desilicated under conditions of a pre-desilication temperature of 105° C., a pre-desilication time of 10 h, and a pre-desilication solid content of 600 g/L to obtain a pre-desilicated slurry. The pre-desilicated slurry was preheated to 240° C. and then kept at that temperature in a pressure cooker for 60 min to obtain a dephosphorized slurry. Then, the dephosphorized slurry was heated to 265° C. and digested for 60 min to obtain a digested bauxite slurry.

### Example 3

Bauxite #1 was treated using the technical solution. The bauxite, lime, a circulating mother liquor, and a small amount of red mud were ball-milled according to a certain proportion to prepare a raw bauxite slurry. In the raw bauxite slurry, an added amount of lime was 5% of the weight of the bauxite, and an added amount of red mud was 8% of the weight of the bauxite. The raw bauxite slurry was pre-desilicated under conditions of a pre-desilication temperature of 105° C., a pre-desilication time of 10 h, and a pre-desilication solid content of 600 g/L to obtain a pre-desilicated slurry. The pre-desilicated slurry was preheated to 250° C. and then kept at that temperature in a pressure cooker for 60 min to obtain a dephosphorized slurry. Then, the dephosphorized slurry was heated to 270° C. and digested for 60 min to obtain a digested bauxite slurry.

### Example 4

Bauxite #1 was treated using this technical solution. The bauxite, lime, a circulating mother liquor, and a small amount of red mud were ball-milled according to a certain proportion to prepare a raw bauxite slurry. In the raw bauxite slurry, an added amount of lime was 5% of the weight of the bauxite, and an added amount of red mud was 10% of the weight of the bauxite. The raw bauxite slurry was pre-desilicated under conditions of a pre-desilication temperature of 105° C., a pre-desilication time of 10 h, and a pre-desilication solid content of 600 g/L to obtain a pre-desilicated slurry. The pre-desilicated slurry was preheated to 260° C. and then kept at that temperature in a pressure cooker for 40 min to obtain a dephosphorized slurry. Then, the dephosphorized slurry was heated to 270° C. and digested for 60 min to obtain a digested bauxite slurry.

### Example 5

Bauxite #2 was treated using this technical solution. The bauxite, lime, a circulating mother liquor, and a small amount of red mud were ball-milled according to a certain proportion to prepare a raw bauxite slurry. In the raw bauxite slurry, an added amount of lime was 8% of the weight of the bauxite, and an added amount of red mud was 2% of the weight of the bauxite. The raw bauxite slurry was pre-desilicated under conditions of a pre-desilication temperature of 95° C., a pre-desilication time of 8 h, and a pre-desilication solid content of 400 g/L to obtain a pre-desilicated slurry. The pre-desilicated slurry was preheated to 230° C. and then kept at that temperature in a pressure cooker for 60 min to obtain a dephosphorized slurry. Then, the dephosphorized slurry was heated to 265° C. and digested for 60 min to obtain a digested bauxite slurry.

### Example 6

Bauxite #2 was treated using this technical solution. The bauxite, lime, a circulating mother liquor, and a small amount of red mud were ball-milled according to a certain proportion to prepare a raw bauxite slurry. In the raw bauxite slurry, an added amount of lime was 8% of the weight of the bauxite, and an added amount of red mud was 5% of the weight of the bauxite. The raw bauxite slurry was pre-desilicated under conditions of a pre-desilication temperature of 105° C., a pre-desilication time of 10 h, and a pre-desilication solid content of 600 g/L to obtain a pre-desilicated slurry. The pre-desilicated slurry was preheated to 240° C. and then kept at that temperature in a pressure cooker for 60 min to obtain a dephosphorized slurry. Then, the dephosphorized slurry was heated to 265° C. and digested for 60 min to obtain a digested bauxite slurry.

### Example 7

Bauxite #2 was treated using this technical solution. The bauxite, lime, a circulating mother liquor, and a small amount of red mud were ball-milled according to a certain proportion to prepare a raw bauxite slurry. In the raw bauxite slurry, an added amount of lime was 8% of the weight of the bauxite, and an added amount of red mud was 8% of the weight of the bauxite. The raw bauxite slurry was pre-desilicated under conditions of a pre-desilication temperature of 105° C., a pre-desilication time of 10 h, and a pre-desilication solid content of 600 g/L to obtain a pre-desilicated slurry. The pre-desilicated slurry was preheated to 250° C. and then kept at that temperature in a pressure cooker for 60 min to obtain a dephosphorized slurry. Then, the dephosphorized slurry was heated to 270° C. and digested for 60 min to obtain a digested bauxite slurry.

### Example 8

Bauxite #2 was treated using this technical solution. The bauxite, lime, a circulating mother liquor, and a small amount of red mud were ball-milled according to a certain proportion to prepare a raw bauxite slurry. In the raw bauxite slurry, an added amount of lime was 8% of the weight of the bauxite, and an added amount of red mud was 10% of the weight of the bauxite. The raw bauxite slurry was pre-desilicated under conditions of a pre-desilication temperature of 105° C., a pre-desilication time of 10 h, and a pre-desilication solid content of 600 g/L to obtain a pre-desilicated slurry. The pre-desilicated slurry was preheated to 260° C. and then kept at that temperature in a pressure cooker for 40 min to obtain a dephosphorized slurry. Then, the dephosphorized slurry was heated to 270° C. and digested for 60 min to obtain a digested bauxite slurry.

The operation cycles of digestion pipelines in the method for digesting the bauxite slurry described in Examples 1-8 and Comparative Examples 1-2 above are shown in Table 1.

TABLE 1
Operation Cycle of Digestion Pipelines

| Serial No. | Operation Cycle of Digestion Pipelines/days |
|---|---|
| Comparative Example 1 | 35 |
| Comparative Example 2 | 25 |
| Example 1 | 50 |
| Example 2 | 59 |
| Example 3 | 63 |
| Example 4 | 65 |
| Example 5 | 40 |
| Example 6 | 50 |
| Example 7 | 52 |
| Example 8 | 55 |

Through the method for digesting a bauxite slurry according to the embodiments of the disclosure, the formation of phosphorus scale in digestion pipelines is effectively slowed down, and the formation of silicon and titanium scale is also slowed down, thereby greatly extending the operation cycle (as shown in Table 1) and reducing the number of scale cleaning. At the same time, this technology also has the advantages of low investment, low cost, and ease of industrial application.

The method for digesting a bauxite slurry according to some embodiments of the disclosure has the following advantages compared with the related art:

The method for digesting a bauxite slurry according to some embodiments of the disclosure adds a step of preheating for dephosphorization after a step of obtaining the raw bauxite slurry and the pre-desilicated slurry and before digesting the slurry. This is conducive to a reaction of phosphorus minerals in the bauxite to form hydroxyapatite and enter the red mud, thereby reducing a phosphorus content in the solution and slowing down scaling in digestion pipelines. Compared with the related art, this method can effectively slow down the formation of phosphorus scale in digestion pipelines, and also slow down the formation of silicon and titanium scale, greatly extending the operation cycle and reducing the number of scale cleaning. This method also has the advantages of low investment, low cost, and ease of industrial application.

The foregoing descriptions are merely specific embodiments of the disclosure, enabling those skilled in the art to understand or implement the disclosure. Various modifications to these embodiments will be obvious to those skilled in the art. The general principles defined herein can be implemented in other embodiments without departing from the spirit or scope of the disclosure. Therefore, the disclosure is not to be limited to the embodiments shown herein, but is to be accorded the widest scope consistent with the principles and novel features disclosed herein.

1. A method for digesting a bauxite slurry, comprising:
obtaining a raw bauxite slurry;
pre-desilicating the raw bauxite slurry to obtain a pre-desilicated slurry;
preheating the pre-desilicated slurry to obtain a dephosphorized slurry; and,
digesting the dephosphorized slurry to obtain a digested bauxite slurry.

2. The method according to claim 1, wherein process parameters for the preheating comprise: a preheating temperature and a preheating time.

3. The method according to claim 2, wherein the preheating temperature ranges from 220° C. to 260° C.

4. The method according to claim 3, wherein the preheating temperature ranges from 240° C. to 260° C.

5. The method according to claim 2, wherein the preheating time is greater than 30 min.

6. The method according to claim 1, wherein the obtaining the raw bauxite slurry comprises:
grinding a bauxite, lime, circulating mother liquor, and red mud to obtain the raw bauxite slurry.

7. The method according to claim 6, wherein an added weight of the red mud is 1% to 10% of an added weight of the bauxite.

8. The method according to claim 6, wherein an added weight of the lime is 3% to 12% of the added weight of the bauxite.

9. The method according to claim 1, wherein process parameters for the pre-desilication comprise: a pre-desilication temperature, a pre-desilication time, and a pre-desilication solid content; wherein,
the pre-desilication temperature ranges from 90° C. to 105° C., the pre-desilication time ranges from 6 h to 15 h, and the pre-desilication solid content ranges from 300 g/L to 1000 g/L.

10. The method according to claim 1, wherein a temperature of the digesting ranges from 260° C. to 280° C.

11. The method according to claim 3, wherein the preheating time is greater than 30 min.

12. The method according to claim 4, wherein the preheating time is greater than 30 min.

13. The method according to claim 7, wherein an added weight of the lime is 3% to 12% of the added weight of the bauxite.
